(19) United States
(12) Patent Application Publication
(10) Pub. No.: US 2012/0188554 A1
(43) Pub. Date: Jul. 26, 2012

(54) LIGHT SOURCE DEVICE AND IMAGING APPARATUS USING THE SAME

(75) Inventors: Yukihiro Inoue, Yokohama-shi (JP); Tomohiro Yamada, Yokohama-shi (JP); Makoto Oigawa, Kawasaki-shi (JP)

(73) Assignee: CANON KABUSHIKI KAISHA, Tokyo (JP)

(21) Appl. No.: 13/355,271

(22) Filed: Jan. 20, 2012

(30) Foreign Application Priority Data
Jan. 24, 2011 (JP) 2011-012046

(51) Int. Cl. G01B 9/02; G02B 6/10

(52) U.S. Cl. 356/479; 362/551

(57) ABSTRACT

A light source device includes an optical resonator that includes an optical gain medium amplifying light and an optical waveguide having wavelength dispersion of a refractive index, and an optical modulator that modulates an intensity of the light in the optical resonator. An oscillation wavelength of an optical pulse is varied according to a modulation frequency of the optical modulator. The optical modulator can adjust transmittance of the light passing through the optical modulator, and a duty ratio of a transmission time of the light passing through the optical modulator is less than 50%.

### BACKGROUND OF THE INVENTION

1. Field of the Invention

The present invention relates to a light source device capable of changing an oscillation wavelength and an imaging apparatus using the light source device.

2. Description of the Related Art

Light sources, particularly laser light sources varying an oscillation wavelength, have been used in various fields such as communication networks and inspection apparatuses. In the field of communication networks, a wavelength needs to be switched at high speed. In the field of inspection apparatuses, a wide range of wavelengths needs to be swept at high speed.

A light source which varies (sweeps) a wavelength for an inspection apparatus finds its application in a laser spectrometer, a dispersion measuring apparatus, a film thickness measuring apparatus, a swept source optical coherence tomography (SS-OCT) apparatus, or the like. Optical coherence tomography (OCT) is an imaging technique that has recently been studied actively in a medical field since a space resolution of micrometer order can be obtained by imaging a tomogram of a specimen using optical interference, and a specimen can be inspected noninvasively.

In the SS-OCT technique, it is expected to acquire an image with a small loss of the amount of light and a high SN ratio, since depth information is obtained using spectrum interference without using a spectrometer. In a medical imaging apparatus configured by applying the SS-OCT technique, the faster a sweep speed is, the shorter an image acquisition time is. Moreover, the larger a wavelength sweep width is, the higher the spatial resolution of a tomogram is. Accordingly, the parameters such as the sweep speed and the wavelength sweep width are important.

Specifically, on the assumption that Δλ is a wavelength sweep width and λ0 is an oscillation wavelength, a depth resolution is expressed as follows.

$$\frac{2 ln 2}{π} \times \frac{{λ}_{0}^{2}}{Δλ} \qquad Expression ( 1 )$$

Accordingly, in order to increase the depth resolution, the wavelength sweep width needs to be expanded and a wide-band wavelength sweep light source is required.

On the other hand, the SS-OCT apparatus can preferably detect a deep structure of a specimen, that is, realize a long coherence length. Accordingly, as the performance of the light source of the SS-OCT apparatus, an oscillation spectrum line width is preferably narrower. Specifically, on the assumption that Δω is an oscillation spectrum line width, a coherence length is expressed as follows.

$$\frac{c}{Δω} \qquad Expression ( 2 )$$

where c is the speed of light in vacuum.
Accordingly, in order to increase the measurement range of a specimen in the depth direction of the specimen, the oscillation spectrum line width needs to be narrowed and a wavelength sweep light source of a narrow line width is required.

Nakazaki et al., in an article entitled “Fast and wide tuning range wavelength-swept fiber laser based on dispersion tuning and its application to dynamic FBG sensing”, Opt. Exp. Vol. 17, pp. 8310 to 8318 (2009) (hereinafter, referred to as “Non-patent Literature 1”) disclose a dispersion tuning method of varying a wavelength using the wavelength dispersion of a refractive index in a resonator. In the Non-patent Literature 1 document, a baseband used mainly in a communication field as the light source for the SS-OCT apparatus has been studied.

According to the dispersion tuning method, an oscillation wavelength in an active mode synchronization state is controlled using the fact that a free spectral range (FSR) of the resonator is dependent on a wavelength. That is, wavelength sweeping is performed by varying the frequency of a modulation signal for obtaining active mode synchronization. Therefore, the wavelength sweeping can be realized at high speed by varying the frequency of the modulation signal at high speed.

Herein, the FSR indicates a frequency range of a resonator mode with respect to light circling in the resonator. On the assumption that c is the velocity of light in vacuum, n is the refractive index of a resonator, and L is the length of the resonator, the FSR is expressed by Expression (3).

$$FSR = \frac{c}{nL} \qquad Expression ( 3 )$$

The dispersion tuning method is a technique for sweeping a central wavelength at the mode synchronization time by sweeping the frequency of the modulation signal by the use of the fact that the FSR is dependent on a wavelength.

In the Non-patent Literature 1 document, a wavelength sweep range Δλ according to the dispersion tuning method is expressed as follows.

$$Δλ = \frac{1}{\vert D \vert {Lf}_{m 0}} \qquad Expression ( 4 )$$

where D is a dispersion parameter and fₘ₀ is the frequency (mode synchronization frequency) of a modulation signal.

In the wavelength sweeping according to a general dispersion tuning method, since a plurality of modes of a constant phase relation are simultaneously oscillated due to a mode synchronization laser, the spectrum line width of an oscillation spectrum can become relatively broad. Further, when a narrow spectrum line width is necessary, it is practically difficult to sufficiently narrow the spectrum line width.

On the contrary, according to the Non-patent Literature 1, the oscillation spectrum line width can be narrowed by increasing the frequency fₘ₀ of the modulation signal and stabilizing the oscillation wavelength by the mode synchronization.

However, when the frequency fₘ₀ of the modulation signal is simply increased, the wavelength sweep range Δλ in Expression (4) may decrease, thereby deteriorating the depth resolution. Further, when the dispersion parameter D or the length L of the resonator is set to be small and the wavelength sweep range Δλ is made to be large to prevent the deterioration in the depth resolution, the wavelength dispersion in the resonator becomes small and the oscillation spectrum line width consequently becomes broad.

### SUMMARY OF THE INVENTION

The present invention is directed to a light source device capable of narrowing an oscillation spectrum line width and also expanding a wavelength sweep range, and an imaging apparatus using the light source device.

According to an aspect of the present invention, a light source device includes an optical resonator including an optical gain medium amplifying light and an optical waveguide having wavelength dispersion of a refractive index, and an optical modulator configured to modulate an intensity of the light in the optical resonator, wherein an oscillation wavelength of an optical pulse is varied according to a modulation frequency of the optical modulator, and wherein the optical modulator adjusts transmittance of the light passing through the optical modulator and a duty ratio of a transmission time of the light passing through the optical modulator is less than 50%.

Further, since a non-transmission time of the light is relatively long, a repetition period of optical modulation can be made to be long (the repetition frequency can be made to be small), thereby expanding the wavelength sweep range by Expression (4).

In other words, the oscillation spectrum line width of an optical pulse can be narrowed by shortening the transmission time of the light passing through the optical modulator, and the wavelength sweep range can be expanded by lengthening the repetition period.

Further, since the non-transmission time of the light is long, spontaneous emission optical noise can be reduced, thereby acquiring a reliable optical signal with a high SN ratio.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a schematic diagram illustrating an example of a light source device according to a first exemplary embodiment of the invention.

FIGS. 2A and 2B are graphs illustrating an oscillation spectrum in a mode synchronization operation and a transmittance of an optical modulator.

FIGS. 3A and 3B are graphs illustrating an oscillation spectrum and a transmittance of an optical modulator in a light source device according to an exemplary embodiment of the invention.

FIG. 4 is a schematic diagram illustrating a light source device according to a second exemplary embodiment of the invention.

FIG. 5 is a schematic diagram illustrating an imaging apparatus equipped with a light source device according to the present invention.

FIG. 6 is a diagram illustrating an example of an optical modulator.

### DESCRIPTION OF THE EMBODIMENT

Various exemplary embodiments, features, and aspects of the invention will be described in detail below with reference to the drawings.

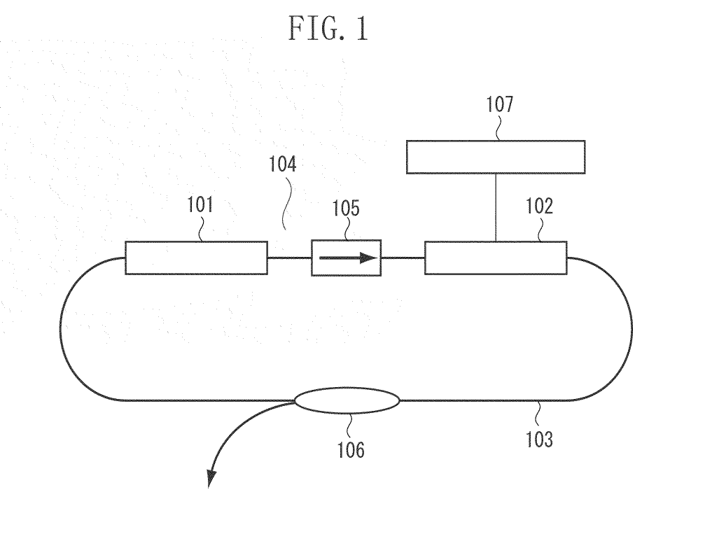

FIG. 1 is a schematic diagram illustrating an example of a light source device according to first exemplary embodiment of the invention. In the light source device illustrated in FIG. 1, an optical resonator 104 includes an optical amplifier 101 as an optical gain medium amplifying light, an optical modulator 102 modulating the intensity of the light, and an optical waveguide 103.

An optical isolator 105 is provided to circulate the light in a single direction, if necessary, when a ring-type resonator is configured as an optical resonator. A coupler 106 extracts light. A driving control unit 107 controls the driving of the optical modulator 102. Here, the optical amplifier 101 will be described using a semiconductor optical amplifier (SOA) as an example.

The optical modulator 102 is an optical element that supplies a modulation signal for modulating the intensity of the light (temporally) in response to a change in the transmittance of the optical resonator 104 to achieve mode synchronization describe below. For example, the optical modulator 102 can be implemented by an electric optical element.

The optical waveguide 103 can be implemented by, for example, a single mode optical fiber having a wavelength-dependent refractive index (wavelength dispersion of a refractive index). The driving control unit 107 is a unit that inputs energy into the optical modulator 102 and controls the transmittance of the optical modulator 102. The driving control unit 107 includes a power supply device and a PC or the like controlling the power supply device.

Hereinafter, an example will be described in which an oscillation spectrum line width is narrowed and a wavelength sweep range is expanded by a light source device according to an exemplary embodiment of the invention, which performs a wavelength sweep operation according to an active mode synchronization method called a dispersion tuning method.

The active mode synchronization method is a method of obtaining a high-frequency pulse oscillation operation of a laser when a plurality of resonator modes are simultaneously exited (longitudinal multi-mode oscillation) and a phase relation between the plurality of resonator modes is made to be constant.

In order to determine the longitudinal multi-mode oscillation and the phase relation between the resonator modes, generally, a laser optical system is configured to have nonlinearity and is provided with a kind of optical modulator. For example, when the optical modulator is a transmittance-control-type optical modulator, a sideband is excited on a low-frequency side and a high-frequency side of the initially excited resonator mode by varying the transmittance to the high frequency by the optical modulator.

On the assumption that ω′ is a frequency applied from the optical modulator and ω0 is the frequency of the initially excited resonator mode described above, the sideband is excited to the frequency of ω0+ω′.

Here, when ω′ is equal to a resonator mode interval or an integral multiple of the resonator mode interval, the sideband excites the resonator mode next to ω0. In this way, the resonator modes excite through the sideband with each other, and the longitudinal multi-mode oscillation can be realized.

An interaction is formed between the resonator modes by allowing the resonator to have the nonlinearity that an optical amplification medium or a nonlinear medium, or the optical modulator itself has, so that the phase relation between the resonator modes is determined. As a consequence, a laser oscillates and outputs a pulse string. A method of applying modulation to the resonator from the outside and forcibly causing the mode synchronization state is referred to as an active mode synchronization method.

For example, when the length of the optical resonator is 200 m and the refractive index is about 1.5, the optical circulation length of the optical resonator is about 300 m. Therefore, as for the modulation frequency provided to the resonator from the outside to realize the mode synchronization, light propagating in the optical resonator circulates at about 1 MHz within the optical resonator. Accordingly, the resonator mode interval (free spectral range (FSR)) of the resonator is also about 1 MHz.

Thus, when the driving frequency of the optical modulator is set to 1 MHz or the integral multiple of 1 MHz, the mode synchronization can be obtained. In this state, a pulse string with a repetition frequency which is an integral multiple of 1 MHz is generated. In effect, the pulse string is appropriately used at a frequency which is about 100 times to 1000 times of the repetition frequency to stabilize the mode synchronization operation. In this case, modulation for the mode synchronization is performed at about 100 MHz to 1 GHz.

The dispersion tuning method is an operation method of varying the oscillation wavelength of an active mode synchronization laser by the use of the fact that the FSR of the optical resonator is consequently dependent on a wavelength, when the refractive index of the optical resonator of the laser obtaining the above-described mode synchronization is dependent on a wavelength.

As described above, the active mode synchronization can be realized by applying modulation of the FSR or the integral multiple of the FSR that the optical resonator has at an oscillation frequency band. In the dispersion tuning method, the oscillation wavelength of the mode synchronization is varied by varying the modulation frequency due to the fact that the FSR is dependent on a wavelength.

That is, in the dispersion tuning method, the oscillation wavelength in the mode synchronization state is varied by varying the repetition frequency, when an amplification factor of the optical amplification medium or the transmittance of the optical modulator is changed.

On the assumption that n(v) is the refractive index of the optical resonator and L is the length of the resonator, the FSR is expressed by Expression (5) below:

$$FSR ( v ) = \frac{c}{n ( v ) \times L} . \qquad Expression ( 5 )$$

Further, the active mode synchronization can be obtained by applying modulation of the amplification factor or modulation of the transmittance at a frequency fm of a natural number multiple (x a) of the FSR, and the wavelength sweeping is realized according to the dispersion tuning method by varying the frequency fm. As understood from the description, the light source sweeping a wavelength according to the dispersion tuning method is basically a mode synchronization laser.

As described above, the refractive index of the optical resonator is dependent on a wavelength. In other words, the optical resonator may have wavelength dispersion of a strong refractive index, and the optical waveguide of the optical resonator may be configured by a member that has wavelength dispersion of a strong refractive index.

On the other hand, the oscillation wavelength of the mode synchronization laser is determined by the modulation frequency of the optical modulator. However, when the amount of change in the modulation frequency is greater than the above-described FSR, the longitudinal mode of the resonator is transferred to a mode of the next order. Therefore, the oscillation wavelength of the laser is not continuously changed and is returned to the wavelength at which the oscillation resumes.

That is, when the modulation frequency in the wavelength sweeping is changed in the order of fₘ₀, fₘ₁, and fₘ₂, the oscillation wavelength is changed into λ0, λ1, and λ2 in response to this change. However, the oscillation wavelength is returned to λ0 when the modulation frequency is shifted to the mode of the neighbor order. Therefore, the modulation frequency cannot be changed over the FSR.

Accordingly, the wavelength sweepable range Δλ is expressed by Expression (4) below.

$$Δλ = \frac{1}{\vert D \vert {Lf}_{m 0}} . \qquad Expression ( 4 )$$

In this expression, D is a dispersion parameter of the resonator and fₘ₀ is a frequency (mode synchronization frequency) of a modulation signal.

In Expression (4), the modulation frequency fₘ₀ and the wavelength sweep range Δλ have a relation in which the larger the modulation frequency fₘ₀ is, the narrower the wavelength sweep range Δλ is. However, the oscillation range greater than a gain range cannot be obtained, since Expression (4) is satisfied within the gain range of an amplification medium.

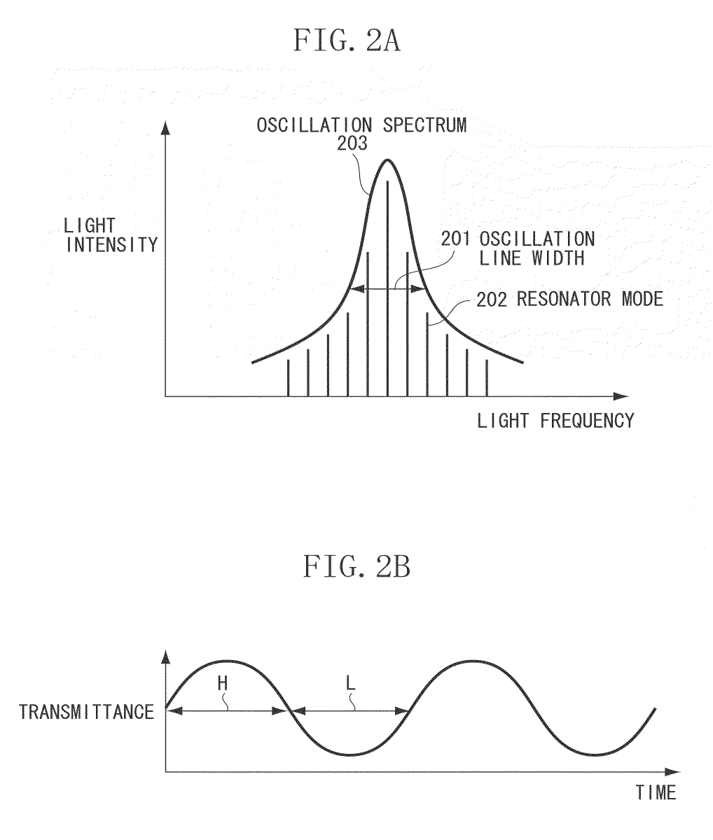

FIG. 2A is a graph illustrating an oscillation spectrum of an optical pulse in the mode synchronization operation, and FIG. 2B is a graph illustrating the transmittance of the optical modulator in the mode synchronization operation. In FIG. 2A, an oscillation line width 201 is a synthetic line width of the longitudinal multi-mode oscillation in the mode synchronization operation. FIG. 2A illustrates each resonator mode 202 and an oscillation spectrum 203.

In FIG. 2B, H (High) represents a transmission time of light passing through the optical modulator and L (Low) represents a non-transmission time.

The transmission time of the light passing through the optical modulator is a time in which the transmittance of the light passing through the optical modulator is 50% or more. Further, the transmittance of light is preferably 99% or more. The non-transmission time is a time in which the transmittance of the light passing through the optical modulator is 10% or less. Further, the transmittance of light is preferably 1% or less.

Here, the “transmittance of light” means a value obtained by dividing the intensity of light exiting from the optical modulator with the intensity of light incident on the optical modulator.

Here, the inventors have recognized that a method of suppressing a sideband excited near the central frequency at the oscillation time is useful to narrow the spectrum line width of the oscillation wavelength in a laser device performing the mode synchronization operation including the dispersion tuning method.

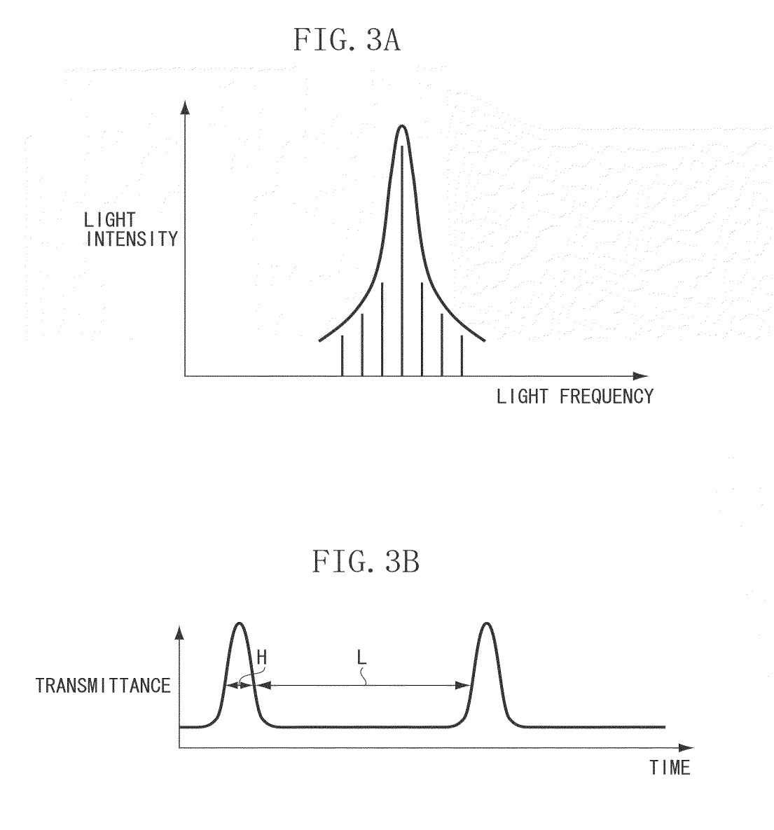

In order to suppress the sideband, the number of modes contributing to the mode synchronization may be reduced. FIG. 3A is a graph illustrating an oscillation spectrum of an optical pulse in the mode synchronization operation in which the number of modes has been reduced. Specifically, as compared to FIG. 2A, FIG. 3A illustrates an oscillation line width narrower than the line width 201 of FIG. 2A. This significant narrowing in the line width of the longitudinal multi-mode oscillation in the mode synchronization operation is attributed to a variation in the transmission time of the light passing through the optical modulator, as illustrated in FIG. 3B.

Specifically, as illustrated in FIG. 3B, the transmission time of the light passing through the optical modulator can be reduced by shortening the pulse width of the modulation signal to be applied to the optical modulator. In FIG. 3B, H represents a transmission time of the light passing through the optical modulator and L represents a non-transmission time.

According to the invention, a duty ratio (H/(H+L)) of the transmission time of the light passing through the optical modulator is set to 50% or less. The number of modes contributing to the mode synchronization can be reduced by temporally restricting the transmitted light. Accordingly, the oscillation line width of the light source in the mode synchronization operation is consequently narrowed compared to a case where the transmission time of light is long.

According to the present exemplary embodiment, the duty ratio of the transmission time of the light passing through the optical modulator is preferably 20% or less to obtain a reliable effect. The duty ratio of the transmission time is more preferably 10% or less to obtain a more reliable effect.

For example, when it is assumed that the transmission time of the light passing through the optical modulator is 500 picoseconds (ps) and the non-transmission time is 500 ps, that is, the duty ratio is 50%, the oscillation line width of light oscillated from the light source is 0.1 nm. On the other hand, when it is assumed that the transmission time of the light passing through the optical modulator is 100 ps and the non-transmission time is 900 ps, that is, the duty ratio is 10%, the oscillation line width of light oscillated from the light source is 0.05 nm.

When it is considered that the SS-OCT apparatus is particularly applied to ocular fundus measurement, a coherence length (corresponding to a measurement range in a depth direction) is preferably 3 mm or more. The frequency of the spectrum line width corresponding to the coherence length of 3 mm is about 100 GHz. That is, the light source of an OCT apparatus for the ocular fundus measurement preferably oscillates with a line width equal to or less than this value.

From the above-described viewpoint, the inventors have studied and learned that an appropriate transmission time Δt of the light passing through the optical modulator is set within the range expressed by Expression (6) below. That is, on the assumption that Δt (seconds) is the transmission time of the light passing through the optical modulator, an expression below is satisfied:

$$4.4 \times {10}^{- 12} < Δ t < DL \frac{{λ}^{2}}{{cf}_{m 0}} \times {10}^{22} , \qquad Expression ( 6 )$$

where fₘ₀ is the modulation frequency of the optical modulator, D is a dispersion parameter of the optical waveguide, L is the resonator length of the optical resonator, λ is the oscillation wavelength of the light source, and c is the velocity of light in vacuum.

The right side of Expression (6) is a value proportional to the wavelength dispersion of the entire resonator, and is the upper limit of the transmission time Δt necessary for a reliable mode synchronization operation. The left side of Expression (6) represents an optical pulse time width when an optical output is an ideal Gauss-type transform limit optical pulse.

When the frequency of the modulation signal is simply increased to reduce the transmission time of the light passing through the optical modulator, the wavelength sweep range is narrowed by Expression (4). Accordingly, it is possible to narrow the oscillation spectrum line width and expand the wavelength sweep range as well by the technique for reducing the transmission time of the optical modulator and lengthening a repetition period (or reducing the repetition frequency).

A specific example will be described below, in which the duty ratio of the transmission time of the light passing through the optical modulator is made to be 50% or less.

In FIG. 1, the optical modulator 102 is configured as an LN (Lithium-Niobate: LiNbO₃) intensity modulator when an electric current equal to or greater than an oscillation threshold value is supplied to the SOA 101 connected to a DC current source (not illustrated). In this case, for example, the driving control unit 107 includes a signal generator that outputs a voltage signal with a constant frequency, and a pulse generator that outputs an output time-variable voltage pulse in synchronization with the constant frequency.

The voltage signal with the constant frequency fₘ₀ generated by the signal generator is input to the pulse generator. A voltage pulse with the repetition frequency fₘ₀ and the duty ratio of 50% or less can be output by setting the output time of the voltage pulse generated by the pulse generator to ½ fₘ₀ or less. The duty ratio of the transmission time can be made to be 50% or less by applying the voltage pulse to the NL intensity modulator.

Further, the driving control unit 107 may include a duty ratio-variable pulse generator. Furthermore, the driving control unit 107 may include a signal generator that outputs a voltage signal with the constant frequency fₘ₀ and a signal generator that outputs a voltage signal with a frequency equal to or greater than 2×fₘ₀. The duty ratio of the transmission time can be made to be 50% or less by superimposing the two output signals with each other and applying the superimposed signal to the LN intensity modulator.

According to the present exemplary, it is possible to obtain the advantage of reducing spontaneous emission optical noise of the generated optical pulse. The spontaneous emission optical noise is continuous light having a temporally constant intensity.

When the spontaneous emission optical noise is circulated in the resonator, the spontaneous emission optical noise first passes through the optical modulator and is modulated in a pulse form. At this time, since the light intensity of a valley portion of the pulse is weak, the spontaneous emission optical noise is reduced.

The spontaneous emission optical noise modulated in the pulse form in this way receives wavelength dispersion in the resonator and spreads temporally. When the temporally spread spontaneous emission optical noise passes through the optical modulator again, the spontaneous emission optical noise is modulated in a pulse form again. By repeating the operations, the light intensity of the spontaneous emission optical noise is weakened. Accordingly, a reliable optical signal with a high SN ratio can be obtained.

When the duty ratio (H/(H+L)) of the transmission time of the light passing through the optical modulator is set to be less than 10%, this effect is more apparent.

As described above, the SOA is used as an example of the optical gain medium. Further, an optical fiber to which a rare earth element including erbium, neodymium, or the like is added, an optical fiber to which pigment including Rhodamine 6G, or the like is added to perform amplification by the pigment, or the like may be used as the optical amplification medium.

The rare-earth-added optical fiber is suitable to obtain satisfactory noise characteristics with a high gain. As for the pigment-added optical fiber, choices of variable wavelengths increase by appropriately selecting a fluorescent pigment material, the host material, or the like.

The SOA is preferably small in size and is controlled at high speed. Both a resonator-type optical amplifier and a travelling waveform optical amplifier can be used as the SOA. A compound semiconductor or the like forming a general semiconductor laser can be used as the material of the SOA. Specifically, examples of the compound semiconductor include an InGaAs-based compound semiconductor, an InAsP-based compound semiconductor, a GaAlSb-based compound semiconductor, a GaAsP-based compound semiconductor, an AlGaAs-based compound semiconductor, and a GaN-based compound semiconductor.

For the central wavelength of a gain from of the SOA, for example, 840 nm, 1060 nm, 1300 nm, and 1550 nm can be selected and employed according to the usage of the light source.

According to the exemplary embodiment, any optical waveguide can basically be used, as long as the optical waveguide has a function of propagating light and wavelength dispersion. A slab waveguide or an optical fiber confining and propagating light is preferably used to suppress the influence from the outside environment as much as possible.

An optical fiber made of quartz (SiO₂) glass, an optical fiber made of plastic, an optical fiber made of both quartz and plastic, or the like can be used as the optical fiber. Further, at least a part of the optical fiber may include chirped fiber Bragg grating (hereinafter, simply referred to as CFBG). The CFBG indicates an optical-fiber-type device that forms a diffractive grating in the core of an optical fiber and varies the period of the diffractive grating in a length direction of the optical fiber.

In the light incident on the CFBG, the light with a wavelength satisfying the Bragg's reflection condition, specifically, the light with a wavelength corresponding to the double of the period of the diffractive grating is reflected. Since the period of the diffractive grating is varied in the length direction of the optical fiber, the wavelength of the light satisfying the Bragg's reflection condition is different depending on a place. That is, since the reflection place is different according to the wavelength, large wavelength dispersion can be provided.

The CFBG has the advantages such as a small loss of the light passing through the CFBG, a small size, and high consistency with a transmission optical fiber, since the diffractive grating can directly be formed in an optical fiber nondestructively by the CFBG. Therefore, the CFBG is appropriately used as an optical waveguide having the wavelength dispersion according to the present exemplary embodiment. CFBG is optical device of the reflecting, so it is necessary to use it with optical coupler or optical circulator when CFBG is used as optical waveguide. In this case, as for the optical resonator, a σ-type resonator is adopted.

According to the present exemplary embodiment, a predetermined dispersion value of the wavelength dispersion of the optical waveguide can be adopted in a range of a normal dispersion (negative dispersion value) to an abnormal dispersion (positive dispersion value) in consideration of an optical amplification medium to be adopted, a sweep speed to be obtained, a sweep wavelength range, or the like.

The wavelength dispersion is preferably 10 ps/nm or more, and is more preferably 100 ps/nm or more. Alternatively, the wavelength dispersion is preferably −10 ps/nm or less, and is more preferably −100 ps/nm or less.

An example of the optical modulator is a waveguide-type modulator capable of performing modulation at high speed. A specific example of the optical modulator is an electric field absorption type optical modulator (EA modulator) or an LN intensity modulator (using a LiNbO₃ substrate) using an electro-optic effect (Pockels effect). The LN intensity modulator is capable of performing control at high speed, since the LN intensity modulator including an interference system performs ON/OFF control of the light by a change in an interference state obtained by varying the refractive index.

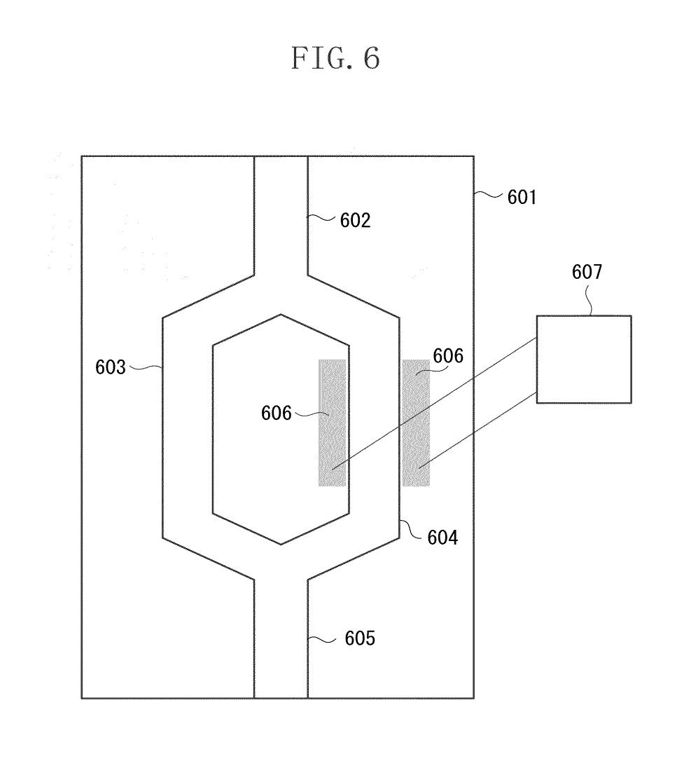

Hereinafter, an example of the LN intensity modulator will be described with reference to FIG. 6. In the LN intensity modulator, for example, a light path is formed on a LiNbO₃ substrate 601, the light path of light to be incident in the light path 602 is diverged into two light paths 603 and 604, and the two diverged light paths 603 and 604 are connected to one light path 605 again. A pair of electrodes 606 is formed in one-side light path 604. A signal generator 607 capable of applying any voltage is connected to the pair of electrodes 606.

The refractive index of the light path 604 can be changed by adjusting a voltage to be applied to the pair of electrodes 606 based on a signal transmitted from the signal generator 607. Accordingly, the intensity of the light exiting from the light path 605 can be varied since the phase of the light passing through the light paths 603 and 604 can be differentiated by adjusting the voltage to be applied to the pair of electrodes 606.

For example, the intensity of the light exiting from the light path 605 becomes 0, when the voltage to be applied to the pair of electrodes 606 is adjusted by shifting the phase of the light passing through the light path 603 by n with respect to the phase of the light passing through the light path 604. That is, the transmittance of the light in the LN intensity optical modulator becomes 0.

On the other hand, the intensity of the light exiting from the light path 605 is theoretically equal to the intensity of the light incident in the light path 602, when the voltage to be applied to the pair of electrodes 606 is adjusted so that the phase of the light passing through the light path 603 is made to coincide with the phase of the light passing through the light path 604. That is, the transmittance of the light in the LN intensity optical modulator is theoretically 1.

The case where the transmittance is 0 or 1 has been described above. However, the transmittance can be set to a value other than 0 and 1 by adjusting the voltage to be applied to the pair of electrodes 606. In this way, it is possible to adjust the transmittance of the light passing through the LN intensity modulator.

The electric field absorption type optical modulator is an intensity modulator that uses the fact that an absorption end of a semiconductor is shifted by applying an electric field. The electric field absorption type optical modulator is small in size and can operate at low voltage.

As the optical resonator adopted in the present exemplary embodiment, a straight-line-type resonator, a σ-type resonator, or the like can be adopted as well as the above-described ring-type resonator. An example of the ring-type resonator includes a resonator that uses an optical system propagating light through air or vacuum using a slab waveguide or a mirror, as well as a resonator using an optical fiber.

Examples of the straight-line-type resonator include an optical resonator (so-called Fabry-Perot resonator) that has a pair of flat planes, and a resonator in which an end surface of an optical fiber has a straight line shape and serves as a mirror.

The optical oscillation method according to the present exemplary embodiment is an optical oscillation method of using the light source device according to the exemplary embodiments of the invention. The optical oscillation method includes setting the duty ratio of the transmission time of the light passing through the optical modulator to be less than 50%.

As described above, the oscillation line width of the light oscillated from the light source can be further narrowed by setting the duty ratio of the transmission time of the light passing through the optical modulator to be less than 50%, compared to a case where the duty ratio is set to 50% or more. In order to obtain the reliable effect, the duty ratio of the transmission time of the light passing through the optical modulator is preferably set to be less than 20%. In order to obtain the more reliable effect, the duty ratio is preferably set to be less than 10%.

Hereinafter, a specific exemplary embodiment of the invention will be described in detail.

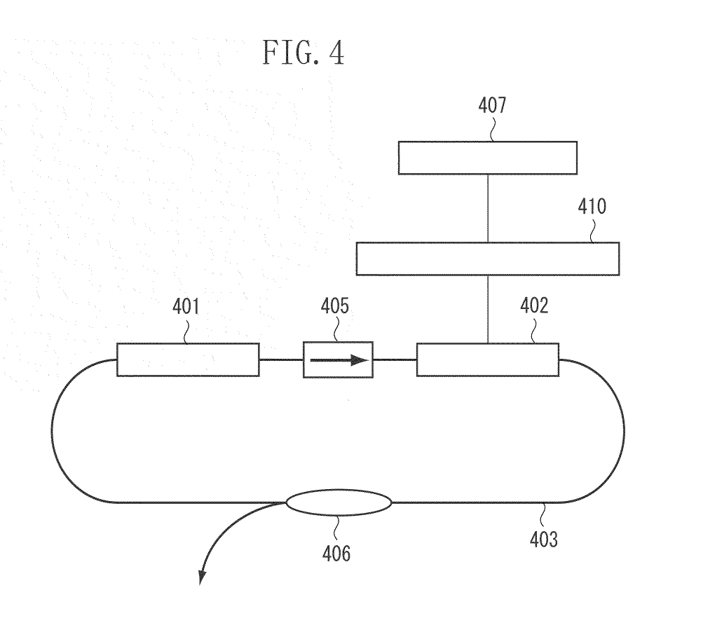

FIG. 4 is a schematic diagram illustrating a light source device according to a second exemplary embodiment. In the light source device illustrated in FIG. 4, an optical resonator includes a semiconductor optical amplifier 401, an LN intensity modulator 402, an optical fiber 403 as an optical waveguide, an isolator 405, and an optical coupler 406. A short-pulse signal generation device 410 is connected to the LN intensity modulator 402. In the short-pulse signal generation device 410, a repetition frequency of a pulse signal is controlled based on a signal transmitted from a high-frequency oscillator 407.

Since the refractive index of the optical fiber 403 is largely dependent on a wavelength (wavelength dispersion, frequency dependency), the smaller the refractive index is, the larger the wavelength is. Therefore, since the FSR of the entire optical resonator is dependent on a frequency, a dispersion tuning operation of varying an oscillation wavelength can be performed by controlling the modulation signal.

The semiconductor optical amplifier has a gain of a wavelength of 800 nm to a wavelength of 880 nm, and the length of the optical resonator including the optical waveguide is 200 m. The optical fiber serving as the optical waveguide is configured with a single mode fiber.

The active mode synchronization is obtained by driving the LN intensity modulator 402 and modulating the transmittance of the modulator at high speed. When the average refractive index of the entire optical resonator is set to 1.46, the FSR of the entire optical resonator is 1.027 MHz by Expression (3).

The repetition frequency of the optical modulation in the active mode synchronization is set to an integral multiple of the FSR. For example, when the frequency of 1000 times the FSR is set, the repetition frequency of the optical modulation is 1.027 GHz.

The sweeping of the oscillation wavelength is performed by varying the frequency of the high-frequency oscillator 407. When the dispersion parameter D of the resonator is set to −100 ps/nm/km, the wavelength sweepable range Δλ is 97.4 nm by Expression (4). However, as described above, the semiconductor optical amplifier has the gain in the wavelength of 800 nm to the wavelength of 880 nm, the wavelength sweeping cannot be performed over this gain band.

In the light source device according to the present exemplary embodiment, the pulse width Δt of the short-pulse signal generation device 406 is set to 150 ps, which satisfies “4.4 ps <Δt <470 ps” by Expression (6). Accordingly, the transmission time of the light passing through the optical modulator is 150 ps, and the non-transmission time is 824 ps. Here, the duty ratio of the transmission time of the light is 18%.

The number of modes contributing to the mode synchronization can be reduced by shortening the transmission time and temporally restricting the transmitted light. Accordingly, the oscillation line width is consequently narrowed.

In the present exemplary embodiment, the transmittance is temporally modulated by the optical modulator, and thus the amplification factor of the entire optical resonator is temporally modulated. However, the modulation method in the optical resonator is not limited thereto, and the optical amplifier may instead perform the function of the optical modulator. In other words, the active mode synchronization can be obtained by temporally modulating the amount of current to be supplied to the optical amplifier and temporally modulating the amplification factor of the entire optical resonator.

A light source device further shortening the transmission time of the light will be described. The light source device has the same configuration as that of the light source device described in the above-described first exemplary embodiment. The pulse width of the short-pulse signal generation device 406 is set to 150 ps, as in the above-described first exemplary embodiment. Unlike the above-described first exemplary embodiment, the repetition frequency of the optical modulation in the active mode synchronization is set to 513.3 MHz which is 500 times the FSR.

Accordingly, the transmission time of the light passing through the optical modulator is 150 ps, and the non-transmission time is 1798 ps. Therefore, the transmission time of the light is about 1/12 of the non-transmission time. Here, the duty ratio of the transmission time of the light is 7.7%.

At that time, a more reliable optical signal with a high SN ratio can be obtained, since the spontaneous emission optical noise of the optical pulse can be further reduced compared to the above-described first exemplary embodiment.

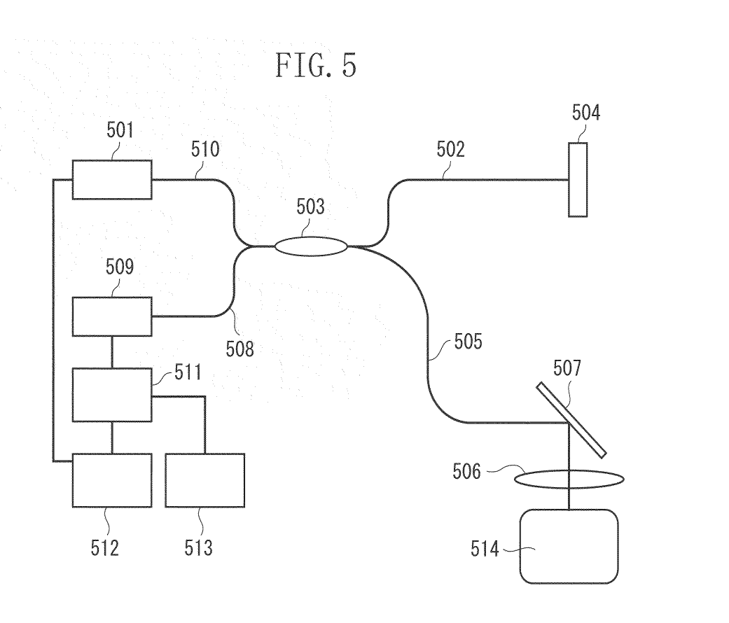

FIG. 5 illustrates an example of an optical coherence tomographic imaging apparatus (imaging apparatus) using the light source according to the invention. Specifically, FIG. 5 is a schematic diagram illustrating an example of an OCT apparatus.

The OCT apparatus illustrated in FIG. 5 includes a light source unit with a wavelength-variable light source 501; a specimen measurement unit including a scanning mirror 507 irradiating a specimen with light from the light source unit and delivering the light reflected from the specimen; a reference unit including a reference light optical fiber 502 for irradiating a reference mirror 504 with the light and delivering the light reflected from the reference mirror 504; an interference unit including a fiber coupler 503 for coupling (interfering) the two pieces of reflected light (i.e. the light reflected from the reference mirror 504 and the light reflected from the specimen); a light detection unit including a photodetector 509 for detecting the interference light obtained from the interference unit; and a signal processing unit (an image processing unit) 511 processing an image (obtaining a tomogram) based on the light detected by the light detection unit. Hereinafter, each unit will be described.

The light source unit includes the wavelength-variable light source 501 and a light source control unit 512 controlling the wavelength-variable light source 501. The wavelength-variable light source 501 is connected to the fiber coupler 503 of the interference unit via an irradiation fiber 510.

The fiber coupler 503 of the interference unit is configured in a single mode at a wavelength band of the light source. Various fiber couplers are configured as 3 dB couplers.

The reflection mirror 504 is connected to the reference light optical path fiber 502, and is included in the reference unit. The fiber 502 is connected to the fiber coupler 503.

The specimen measurement unit includes the inspection light optical path fiber 505, an irradiation condensing optical system 506, and the irradiated-position scanning mirror 507. The inspection light optical path fiber 505 is connected to the fiber coupler 503. In the fiber coupler 503, backscattered light generated from the inside and the surface of an inspection object 514 and returned light from the reference unit are interfered with each other to form interfered light.

The light detection unit includes a light-reception fiber 508 and a photodetector 509. The interfered light generated from the fiber coupler 503 is guided toward the photodetector 509.

A signal processing device 511 converts the light received by the photodetector 509 into a spectrum signal, and performs Fourier transform thereon to acquire depth information regarding an inspected object. The acquired depth information is displayed as a tomogram on an image outputting monitor 513.

Here, the signal processing device 511 may include a personal computer or the like. The image outputting monitor 513 may include a display screen or the like of the personal computer.

In the light source unit according to the present exemplary embodiment, the oscillation wavelength, the intensity, and the time variation of the wavelength-variable light source 501 are controlled by the light source control unit 512.

The light source control unit 512 is connected to the signal processing device 511 that also controls a driving signal or the like of the irradiated-position scanning mirror 507. The wavelength-variable light source 501 is controlled in synchronization with the driving of the irradiated-position scanning mirror 507.

The wavelength-variable light source 501 using the light source device according to the present invention has a narrow spectrum line width while the wavelength sweeping, and can acquire interference images from a position of the same distance as that of the reference mirror to a distant position at the optical interference tomography time. A narrow spectrum width of the oscillation wavelength in the wavelength sweeping corresponds to a long coherence length. That is, the interference signal can be obtained even when there is a large difference between the optical path lengths of two optical paths in an interference optical system. Accordingly, the OCT apparatus using the light source device with the narrow oscillation spectrum line width according to the present invention has the advantage being capable of detecting a deep structure of the inspected object.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-012046 filed Jan. 24, 2011, which is hereby incorporated by reference herein in its entirety.

What is claimed is:

1. A light source device comprising:
an optical resonator including an optical gain medium amplifying light and an optical waveguide having wavelength dispersion of a refractive index; and
an optical modulator configured to modulate an intensity of the light in the optical resonator,
wherein an oscillation wavelength of an optical pulse is varied according to a modulation frequency of the optical modulator, and
wherein the optical modulator adjusts transmittance of the light passing through the optical modulator and a duty ratio of a transmission time of the light passing through the optical modulator is less than 50%.

2. The light source device according to claim 1, wherein the duty ratio of the transmission time is less than 20%.

3. The light source device according to claim 2, wherein the duty ratio of the transmission time is less than 10%.

4. The light source device according to claim 1, an expression below is satisfied:
$$4.4 \times {10}^{- 12} < Δ t < DL \frac{{λ}^{2}}{{cf}_{m 0}} \times {10}^{22}$$
where Δt is the transmission time of the light passing through the optical modulator, fₘ₀ is the modulation frequency of the optical modulator, D is a dispersion parameter of the optical waveguide, L is a resonator length of the optical resonator, λ is the oscillation wavelength of the light source, and c is the velocity of light in vacuum.

5. The light source device according to claim 1, wherein the optical waveguide comprises an optical fiber having the wavelength dispersion of a refractive index.

6. The light source device according to claim 5, wherein at least a part of the optical fiber includes a chirped fiber Bragg grating.

7. An optical coherence tomographic imaging apparatus comprising:
a light source unit including the light source device according to claim 1;
a specimen measurement unit configured to irradiate a specimen with light from the light source unit and deliver light reflected from the specimen;
a reference unit configured to irradiate a reference mirror with the light from the light source unit and deliver light reflected from the reference mirror;
an interference unit configured to interfere the light reflected from the specimen measurement unit and the light reflected from the reference unit;
an optical detection unit configured to detect the light interfered by the interference unit; and
an image processing unit configured to acquire a tomography image of the specimen based on the light detected by the optical detection unit.

8. An method of setting an optical oscillation of a light source device, the light source device including an optical resonator that includes an optical gain medium amplifying light and an optical waveguide having wavelength dispersion of a refractive index, and an optical modulator that modulates an intensity of the light in the optical resonator in which an oscillation wavelength of an optical pulse is varied according to a modulation frequency of the optical modulator, the method comprising:
adjusting, by the optical modulator, transmittance of the light passing through the optical modulator; and
setting a duty ratio of a transmission time of the light passing through the optical modulator to be less than 50%.
